(19) United States
(12) Patent Application Publication
(10) Pub. No.: US 2007/0189127 A1
(43) Pub. Date: Aug. 16, 2007

(54) COMBINATION WATCH DEVICE

(76) Inventor: Isaac Pollak, New York, NY (US)

Correspondence Address: JOHN J. SCHROTH, P.E., 3598 BUTTONWOOD DRIVE, DOYLESTOWN, PA, 18901-5402, US

(21) Appl. No.: 11/464,561

(22) Filed: Aug. 15, 2006

Related U.S. Application Data
(60) Provisional application No. 60/710,744, filed on Aug. 24, 2005.

(51) Int. Cl. G04B 37/00; G04B 39/00

(52) U.S. Cl. 368/294

(57) ABSTRACT

The present invention provides a combined watch device. Multiple pivots connect multiple watch elements to a unifying watch base allowing the definition of a back receiving region and a front receiving region. Front and back receiving regions are on opposite sides of a watch base member and are alternatively closed by a back lid, a pivoting watch body, and a pivoting watch bezel. In this elected embodiment the watch body member pivots on the same axial pivot number as the watch bezel member. Similar urging snap members on the watch body member and on the watch bezel member allow ready connection and securement of the same to the watch base member. A back lid protects and defines a back receiving region within the watch base member.

### CROSS REFERENCE TO RELATED APPLICATIONS

This application claims priority from U.S. Provisional Patent Application Ser. No. 60/710,744, filed Aug. 24, 2005, the contents of which is incorporated herein by reference in its entirety.

### BACKGROUND OF THE INVENTION

1. Field of the Invention

The present invention relates to a combination watch device. More specifically, the present invention relates to a watch device containing a pivotal watch bezel member, a pivoting watch body member, and a pivoting back lid member; all pivotally attached to a joining watch base.

2. Description of the Related Art

The related art involves a number of watch housings and casings with protective pivoting lids. The prior art involves at least U.S. Pat. No. 2,636,338 to Dinstman. The Dinstman reference teaches a watch cover pivotable to protectively cover a watch face and provides a simple barrel hinge and catch mechanism to hold the crystal face relative to the watch body.

### OBJECTS AND SUMMARY OF THE INVENTION

An object of the present invention is to provide a combination watch device having a watch base in pivoting combination with a watch bezel member, a watch body member, a back lid member and having a pass through visible region bisecting the watch base, allowing either a passage between front and rear receiving regions or alternatively a transparent window to see an image stored within rear receiving region.

Another object of the present invention is to provide a combination watch device wherein a watch bezel and a watch body are pivotally attached to a watch base at a combined barrel hinge location opposite separable snap lid connection sections.

Another object of the present invention is to provide a combination watch object having a watch bezel with a snap-top lid and a transparent bezel member wherein the transparent bezel watch member may alternatively include a magnifying member.

Another object of the present invention is to provide a combination watch device wherein a back lid is pivotally attached to a back portion of a watch base and includes a pivot member opposite a snap catch member allowing pivoting of the back lid relative to the watch base thereby exposing a back receiving region for the storage of products or the display of images via a front receiving region defined between the watch body and the watch base.

The present invention relates to a combination watch member wherein a plurality of watch pivot elements are pivotally bound to a watch base and allow adaptive access to a watch body, a bezel, a front receiving region, a back receiving region, and a back lid. The watch body includes both a glass cover and a watch member itself. The front receiving region is a bounded region defined between a pivoting watch body and a watch base. The back receiving region is a bounded region defined between a back lid and the watch base. A plurality of watch straps may be adaptively attached to the watch base allowing application of the device to a number of suspending items including a user's wrist or a desktop or a pole or bar.

According to one aspect of the present invention, there is provided a watch assembly, comprising: a first watch body case member having a front side and a back side and a bounded front and back receiving there within, at least a first window-opening between the front and back sides, a watch body member pivotally engaged with the front side of the first watch body case member at a first pivot side of the watch body, a watch bezel member pivotally engaged with the front side of the first watch body member at the first pivot side of the watch body, and a rear back member pivotally engaged with one side of the first watch body member on the back side thereof.

According to another aspect of the present invention, there is provided a watch assembly, further comprising: first snap means for snap engaging the a snap engagement side of the watch body member to the front side of the first watch body case member, second snap means for snap engaging a second snap engagement side of the watch bezel member to the front side of the watch body case member, and third snap means for snap engaging a third snap engagement side of the rear back member, whereby the watch body member, the bezel member, and the rear back member may be releasably secured to the first watch body case member.

According to another aspect of the present invention, there is provided a watch assembly, wherein: the watch bezel member includes at least a first bezel protection member covering a face of the watch body member during a use, and the first bezel protection member including at least one of a glass member, a magnifying member, an image member, and a polarizing filter member.

According to another aspect of the present invention, there is provided a watch assembly, further comprising: a front receiving region and a rear receiving region proximate opposing sides of at least first window opening.

According to another aspect of the present invention, there is provided a watch assembly, wherein: the first, the second, and the third snap means each further comprising: at least a first receiving detent region, at least a first urged projection member, and at least a means for elastically urging each respective projection member, whereby during an assembly of the watch assembly, each the elastically urged projection member is depressed relative to a respective urging socket and positioned over respective the first receiving detent region whereupon the means for elastically urging positions a portion of the respective projection member within respective the detent region.

According to another aspect of the present invention, there is provided a watch assembly, further comprising: at least a means for simultaneously positioning the first and the second snap means over respective the detent regions on a common side of the watch body case member without a pivoting interference there between.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a top perspective view of one embodiment of the present invention.

FIG. 2 is a partially open bottom perspective view of the embodiment in FIG. 1.

FIG. 3 is a close up sectional view of the attachment mechanism of the back member shown in view I in FIG. 2.

FIG. 4 is a partial cross sectional view of a band attachment and detent taken along section II-II in FIG. 2.

FIG. 5 is a top perspective view of the embodiment of the present invention shown in FIG. 1.

FIG. 6 is a partial cross sectional view along line III-III in FIG. 5.

FIG. 7 is a partial sectional view along line IV-IV in FIG. 5 noting the snap clamp member for the watch body member.

FIG. 8 is a partial sectional view along line V-V in FIG. 5 noting the snap clamp member for the watch bezel member.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

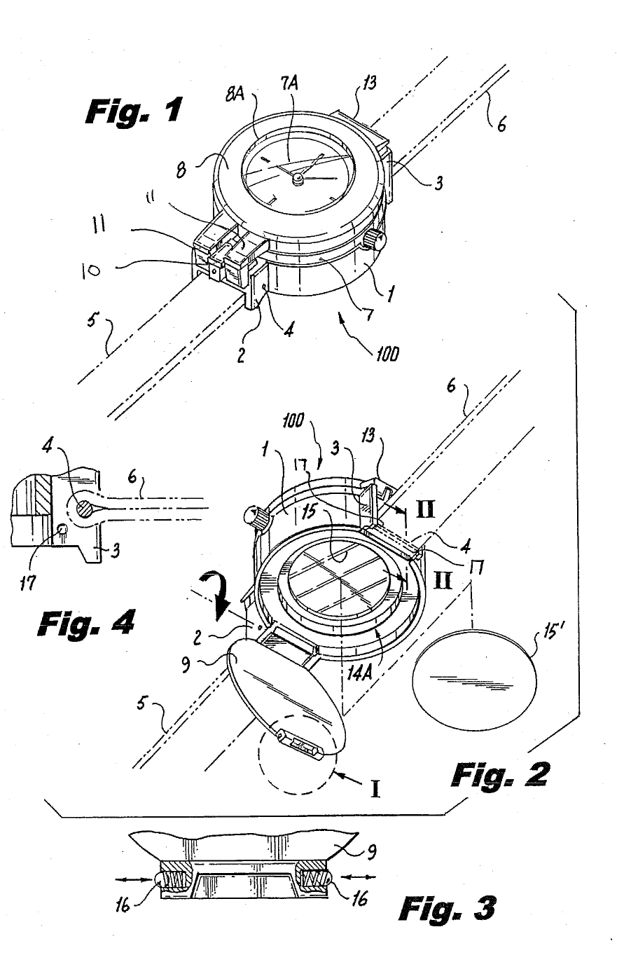

Referring now to FIGS. 1 through 8, a watch body system 100 provides a combination watch device having a watch base member or watch body case 1 pivotally bound to wrist bands 5, 6, at opposing respective hinge strap attachment sights 2, 3 by pivot posts 4 pivotally joined to post-receiving regions in each respective band. As a consequence of the present disclosure those skilled in the jewelry arts will readily recognize that watch body system 100 is readily worn on a wrist in a conventional manner, and as will be described includes and defines a front receiving region 14 and a rear receiving region 14A, as will be discussed.

A watch body member 7 containing a time piece with a human-readable face 7A and a watch bezel cover member 8 with an image area or bezel member 8A are pivotably secured at common pivot 13 on a first side of watch body case 1, as shown. Common pivot 13 joins extending pivot fittings for each watch body member 7 and watch bezel cover member 8, allowing the use of a compact and attractive shape for consumer appeal and allowing the watch member to be considered jewelry and as a novelty item.

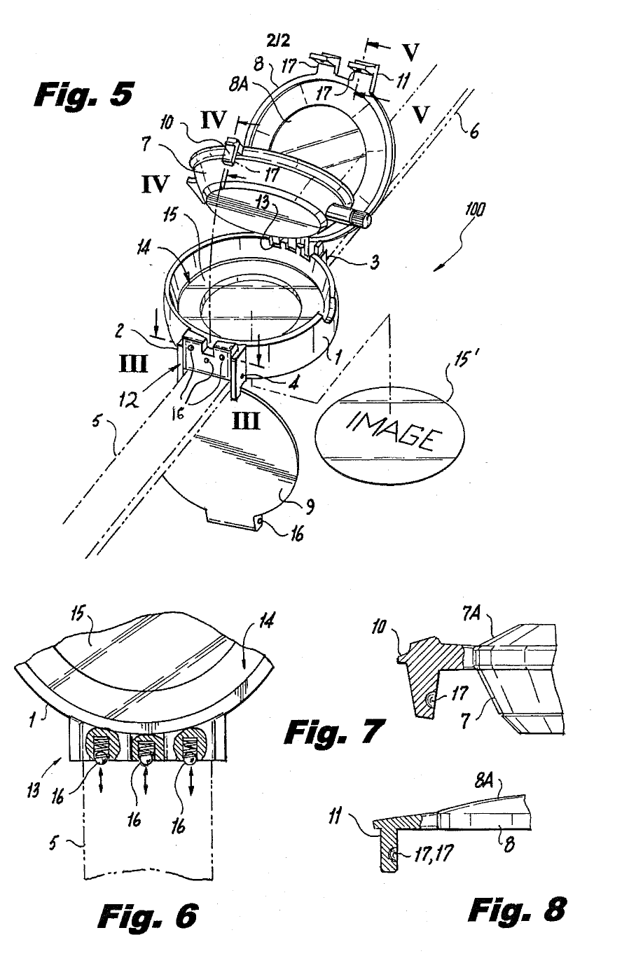

On opposing sides of respective watch body member 7 and watch cover member 8 are formed with respective snap clamp members 10, 11. As can be noted most clearly in FIG. 5, watch body member 7, containing a watch includes a single snap clamp member 11 while watch bezel member 8 includes two bifurcated snap clamp members 10, 10. As assembled, single snap clamp members 10, 10 define a receiving gap there between allowing single snap clamp member 11 to remain engaged, during pivoting of watch cover member 8 away from watch body member 7. Approached in a different manner, those of skill in the consumer jewelry market will recognize that pivot assembly 13 allows both snap clamp members 10, 11 to snap and engage simultaneously three individual urged snap balls 16 received in respective concave detents 17. As shown particularly well in FIG. 6, snap balls 16 are retained within respective cavities and biased outwardly by an internally trapped spring member so as to maintain the balls in an outwardly urged elastic condition so as to readily mesh within detents 17 (FIGS. 7, 8).

As an additional feature of the present invention, one of skill in the art will recognize that watch image area or glass bezel 8A may be alternatively selected from a variety of options according to a manufacturer's preference. These options include, but are not limited to; clear and translucent materials to protect the watch, a magnifying lens to allow a user with insufficient eyesight to readily read watch face 7A. Also considered are the use of translucent or transparent advertising or promotional film layerings (for example a Disney character) may be placed on glass bezel 8A.

On a reverse side of watch body member 7 are back lid member 9 pivotally hinged at a pivot location within hinge housing 2 at a pivot region 12 opposite a pair of outwardly urged snap pins 16, 16 on opposing sides of lid member 9. Snap pins 16 engage corresponding receiving snap detents 17, 17 formed proximate an interior of hinge housing 3 (FIG. 2).

Watch body member 7 is substantially hollow and includes an inner opening region 14 and an optional glass member 15 separating the same from rear opening region 14A.

Front receiving region 14 of watch base 7 is defined and enclosable within and between watch body member 7 and watch base member 1. A back receiving region 14A is defined between back lid member 9 and the defined region within the back portion of watch base 1.

During use a user may open back lid member 9 and place a small photograph or other image 15′ within back receiving region 14A allowing it to be viewed through the removable glass member 15 visible at front receiving region 14. In alternative embodiments back receiving region 14A may be a thicker or thinner or provide alternatively shaped regions sufficient to store change, special jewelry, or other transport items including images. Front receiving region 14 is designed to receive both the watch body member 7 and watch bezel member 8, and also optionally include a receiving region for a winding portion of watch body (shown in FIG. 5).

In an alternative embodiment both the transparent member 8A of watch bezel member 8 is magnifying and glass member 7A in watch body member 7 protects watch hands and other watch mechanisms is similarly magnified. Thus in this alternative embodiment the combined magnification effects of watch bezel member 8 and watch body cover member 7A may enable a multiplicative magnification effect for a user thereby allowing manufacturers to employ very small watch mechanisms that are normally difficult to see for the common user.

In view of the above, wherein FIG. 1 through FIG. 8 specifically describe one alternative but also other reasonably inferred embodiments, those skilled in the art of jewelry and combined watch assemblies will additionally recognize that different designs are available to adapt to the commercial desires of the consuming public. As a consequence, one alternative embodiment would enable a water-tight sealing between various pivoting members and watch base 1 thereby protecting each delicate assembly and allowing the combined device to be used as an underwater or adventure watch, perhaps with a polarized bezel film to avoid glare on region 8A.

An additional alternative embodiments, those of skill in the art should recognize that the present invention alternatively includes the option of having watch bezel 8 be pivotally attached not to watch base member 1 but instead to watch body member 7 either at the same side as the present pivot or for interest and character to the opposing pivot side currently occupied by snap clamp region 2 on watch body member 1. As a result, and this present alternative embodiment the user may first pivot watch body 7 away from watch base exposing front region 7A and then in a different pivot direction open watch bezel member 8.

As may be particularly viewed in FIG. 5, there is shown a winding watch mechanism adjustment device—a knurled knob—projecting laterally from watch body member 7 and resting within a hollowed receiving region of watch base member 1. In this alternative employment watch base member 1 receives the knurled knob and provides protection against unintended damage and bending of the knob thereby preserving and extending the lifetime of the combined watch device.

In any future claims, the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A watch assembly, comprising:
a first watch body case member having a front side and a back side and a bounded front and back receiving there within;
at least a first window-opening between said front and back sides;
a watch body member pivotally engaged with said front side of said first watch body case member at a first pivot side of said watch body;
a watch bezel member pivotally engaged with said front side of said first watch body member at said first pivot side of said watch body; and
a rear back member pivotally engaged with one side of said first watch body member on said back side thereof.

2. A watch assembly, according to claim 1, further comprising:
first snap means for snap engaging said a snap engagement side of said watch body member to said front side of said first watch body case member;
second snap means for snap engaging a second snap engagement side of said watch bezel member to said front side of said watch body case member; and
third snap means for snap engaging a third snap engagement side of said rear back member, whereby said watch body member, said bezel member, and said rear back member may be releasably secured to said first watch body case member.

3. A watch assembly, according to claim 2, wherein:
said watch bezel member includes at least a first bezel protection member covering a face of said watch body member during a use; and
said first bezel protection member including at least one of a glass member, a magnifying member, an image member, and a polarizing filter member.

4. A watch assembly, according to claim 3, further comprising:
a front receiving region and a rear receiving region proximate opposing sides of at least first window opening.

5. A watch assembly, according to claim 4, wherein:
said first, said second, and said third snap means each further comprise:
at least a first receiving detent region;
at least a first urged projection member; and
at least a means for elastically urging each respective projection member, whereby during an assembly of said watch assembly, each said elastically urged projection member is depressed relative to a respective urging socket and positioned over respective said first receiving detent region whereupon said means for elastically urging positions a portion of said respective projection member within respective said detent region.

6. A watch assembly, according to claim 5, further comprising:
at least a means for simultaneously positioning said first and said second snap means over respective said detent regions on a common side of said watch body case member without a pivoting interference there between.
